(19) United States
(12) Patent Application Publication
(10) Pub. No.: US 2011/0128190 A1
(43) Pub. Date: Jun. 2, 2011

(54) WIRELESS COMMUNICATION TERMINAL WITH A SPLIT MULTI-BAND ANTENNA HAVING A SINGLE RF FEED NODE

(75) Inventor: Roustem Galeev, Lund (SE)

(73) Assignee: Sony Ericsson Mobile Communications AB

(21) Appl. No.: 12/629,652

(22) Filed: Dec. 2, 2009

(51) Int. Cl. H01Q 1/24

(52) U.S. Cl. 343/702

(57) ABSTRACT

A wireless communications terminal can include a housing having an interior surface that is configured to enclose at least a transceiver circuit and a RF feed circuit. The housing extends between opposing top and bottom end surfaces and between opposing first and second side surfaces. A first radiator line primarily extends along one of the side surfaces and is connected to the RF feed node and to a first ground node. The first radiator line is configured to resonate in a first frequency range responsive to a first RF signal being provided to the RF feed node. A second radiator line is connected to the RF feed node through a stripline and/or coaxial cable and extends across at least a majority of a width of the housing between first and second side surfaces. The second radiator line is configured to resonate in a second frequency range, which is lower than the first frequency range, responsive to a second RF signal being provided to the RF feed node. The second radiator line can be grounded through the first ground node to resonate in the second frequency range.

### FIELD OF THE INVENTION

The invention generally relates to the field of communications, and more particularly, to antennas that are used by wireless communication terminals for transmission and reception.

### BACKGROUND OF THE INVENTION

Wireless terminals may operate in multiple frequency bands in order to provide operations in multiple communications systems. For example, many cellular radiotelephones are now designed for pentaband operation in GSM and WCDMA modes at nominal frequencies of 850 MHz, 900 MHz, 1800 MHz, 1900 MHz, and 2100 MHz.

Achieving effective performance in all of the above described frequency bands (i.e., “multi-band”) may be difficult. Contemporary wireless terminals are increasingly packing more circuitry and larger displays and keypads/keyboards within small housings. As a consequence, there has been increased use of semi-planar antennas, such as a multi-branch inverted-F antenna, that may occupy a smaller space within a terminal housing. The semi-planar antenna can be printed on/mounted to the terminal's main printed circuit board, but should be placed away from a ground plane of the terminal's printed circuit board to be useful. Constraints on the available space and location for the branches of the antenna can negatively affect the antenna performance.

### SUMMARY

Embodiments according to the invention can provide multi-band antennas for use in wireless communication terminals. In some embodiments, a wireless communications terminal includes a housing having an interior surface that is configured to enclose at least a transceiver circuit and a RF feed circuit. The housing extends between opposing top and bottom end surfaces and between opposing first and second side surfaces. A first radiator line primarily extends along one of the side surfaces and is connected to the RF feed node and to a first ground node. The first radiator line is configured to resonate in a first frequency range responsive to a first RF signal being provided to the RF feed node. A second radiator line is connected to the RF feed node and extends across at least a majority of a width of the housing between first and second side surfaces. The second radiator line is configured to resonate in a second frequency range, which is lower than the first frequency range, responsive to a second RF signal being provided to the RF feed node.

The second radiator line can be grounded through the first ground node to resonate in the second frequency range. The first frequency range resonated by the first radiator line may include frequencies between 1700 and 2700 MHz. The second frequency range resonated by the second radiator line may include frequencies between 800 and 950 MHz.

The first and second radiator lines may be integrally formed as a single conductive layer on a flexible film surface. The first radiator line may extend on the flexible film surface along and be fixedly attached to one of the first and second side surfaces of the housing. The second radiator line may extend on the flexible film surface across the terminal and be fixedly attached to the first and second side surfaces. The first radiator line may be fixedly attached along at least a major length thereof to one of the first and second side surfaces of the housing. The second radiator line may be fixedly attached along at least a major length thereof to the bottom end surface.

The first and second radiator lines may each comprise a flat conductive patch attached to the flexible film surface. The first and second radiator lines may each comprise a meandering conductive path attached to the flexible film surface. The first radiator line may comprise a conductive loop attached to the flexible film surface, and the second radiator line may comprise a flat conductive patch and/or a meandering conductive path attached to the flexible film surface.

The wireless communications terminal may further include a third radiator line that extends parallel to and is closely spaced to the second radiator line and be inductively coupled to the second radiator line to resonate in a third frequency range, which is may be between or higher than the first and second frequency ranges, responsive to the second electromagnetic radiation being provided to the RF feed node. The first frequency range resonated by the first radiator line may include frequencies between 1700 and 2700 MHz. The second frequency range resonated by the second radiator line may include frequencies between 800 and 950 MHz. The third frequency range resonated by the third radiator line may include frequencies between 1800 and 2700 MHz. The third radiator line may extend across the terminal and be fixedly attached to the first and second side surfaces.

The first radiator line may be located within a top region of the housing that is above a central region of the housing which is covered by a user's hand while holding the terminal to position a speaker within the housing adjacent to the user's ear. The second radiator line may be located within a bottom region of the housing that is below the central region of the housing. The first radiator line may be spaced apart from the top end of the housing between a location of the speaker and the central region of the housing.

The wireless communications terminal may further include a printed circuit board that electrically connects and fixedly supports the transceiver circuit, the RF feed circuit, and the RF feed node. The printed circuit board may include opposing major surfaces, and the first and second radiator lines may not overlap either of the opposing major surfaces of the printed circuit board. The second radiator line may be located in a bottom region of the housing relative to how the housing is held by a user to position a speaker within the housing adjacent to the user's ear, and the second radiator line may be spaced apart from an edge of the printed circuit board.

The wireless communications terminal may further include a coaxial cable that conducts the RF signal from the RF feed circuit to the RF feed node.

The first radiator line may extend along a major portion thereof in a first direction, the second radiator line may extend along a major portion thereof in a second direction, and the first and second directions may be substantially perpendicular.

The first radiator line may extend along a major portion thereof in a first direction that is titled at least 10° away from a front surface of the housing so that the first radiator line is more uniformly spaced along its length from a user's fingers while the terminal is held to position a speaker within the housing adjacent to the user's ear.

Some other embodiments are directed to a wireless communications terminal that includes a housing and first, second, and third radiator lines. The housing has an interior surface that is configured to enclose at least a transceiver circuit and a RF feed circuit that provide a RF signal to a RF feed node. The housing extends between opposing top and bottom end surfaces and between opposing first and second side surfaces. The first radiator line primarily extends along one of the side surfaces and is connected to the RF feed node and to a first ground node. The first radiator line resonates in a first frequency range responsive to a first RF signal being provided to the RF feed node. The first radiator line is located within a top region of the housing that is above a central region of the housing which is covered by a user's hand while holding the terminal to position a speaker within the housing adjacent to the user's ear. The second radiator line is connected to the RF feed node and extends across at least a majority of a width of the housing between first and second side surfaces, and is configured to resonate in a second frequency range, which is lower than the first frequency range, responsive to a second RF signal being provided to the RF feed node. The second radiator line is located within a bottom region of the housing that is below the central region of the housing. The third radiator line extends parallel to and is closely spaced to the second radiator line and is inductively/capacitively coupled to the second radiator line to resonate in a third frequency range, which is between than the first and second frequency ranges, responsive to the second electromagnetic radiation being provided to the RF feed node.

The first and second radiator lines may be integrally formed as a single conductive layer on a flexible film surface. The first radiator line may extend on the flexible film surface along and be fixedly attached along at least a major length thereof to one of the first and second side surfaces of the housing. The second radiator line may extend on the flexible film surface across the terminal and be fixedly attached to the first and second side surfaces and is fixedly attached along at least a major length thereof to the bottom end surface.

Other antennas, wireless terminals, methods, and/or systems according to embodiments of the invention will be or become apparent to one with skill in the art upon review of the following drawings and detailed description. It is intended that all such additional antennas, terminals, methods, and/or systems be included within this description, be within the scope of the present invention, and be protected by the accompanying claims. Moreover, it is intended that all embodiments disclosed herein can be implemented separately or combined in any way and/or combination.

### BRIEF DESCRIPTION OF THE DRAWINGS

The accompanying drawings, which are included to provide a further understanding of the invention and are incorporated in and constitute a part of this application, illustrate certain embodiment(s) of the invention. In the drawings:

FIG. 1 illustrates a multi-band wireless communications terminal with a multi-band antenna that is configured according to some embodiments of the present invention;

FIG. 2 illustrates the multi-band antenna of FIG. 1 that has spaced apart first and second radiator lines that are configured according to some embodiments of the present invention;

FIG. 3 is a block diagram that illustrates a side view of exemplary components of the wireless communications terminal of FIG. 1 according to some embodiments of the invention;

FIG. 4 is a functional block diagram of the exemplary components of the wireless communications terminal of FIG. 1 according to some embodiments of the invention; and

FIG. 5 is a graph that illustrates exemplary antenna total efficiency that may be provided by the pentaband antenna of FIGS. 1-4 in a 100 mm long monoblock handset in free space and with phantom head and hand in accordance with some embodiments of the invention.

### DETAILED DESCRIPTION OF EMBODIMENTS ACCORDING TO THE INVENTION

The invention will now be described more fully hereinafter with reference to the accompanying drawings, in which embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

It will be understood that, when an element is referred to as being “coupled” to another element, it can be directly coupled to the other element or intervening elements may be present. In contrast, when an element is referred to as being “directly coupled” to another element, there are no intervening elements present. Like numbers refer to like elements throughout.

Spatially relative terms, such as “above”, “below”, “upper”, “lower” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly. Well-known functions or constructions may not be described in detail for brevity and/or clarity.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of this specification and the relevant art and will not be interpreted in an idealized or overly formal sense expressly so defined herein.

Embodiments of the invention are described herein with reference to schematic illustrations of idealized embodiments of the invention. As such, variations from the shapes and relative sizes of the illustrations as a result, for example, of manufacturing techniques and/or tolerances, are to be expected. Thus, embodiments of the invention should not be construed as limited to the particular shapes and relative sizes of regions illustrated herein but are to include deviations in shapes and/or relative sizes that result, for example, from different operational constraints and/or from manufacturing constraints. Thus, the elements illustrated in the figures are schematic in nature and their shapes are not intended to illustrate the actual shape of a region of a device and are not intended to limit the scope of the invention.

For purposes of illustration and explanation only, various embodiments of the present invention are described herein in the context of tri-band wireless communication terminals (“wireless terminals”/“terminals”) that are configured to carry out cellular communications (e.g., cellular voice and/or data communications) in more than one frequency band. It will be understood, however, that the present invention is not limited to such embodiments and may be embodied generally in any wireless communication terminal that includes a multi-band RF antenna that is configured to transmit and receive in two or more frequency bands.

As used herein, the term “multi-band” can include, for example, operations in any of the following bands: Advanced Mobile Phone Service (AMPS), ANSI-136, Global Standard for Mobile (GSM) communication, General Packet Radio Service (GPRS), enhanced data rates for GSM evolution (EDGE), DCS, PDC, PCS, code division multiple access (CDMA), wideband-CDMA, CDMA2000, and/or Universal Mobile Telecommunications System (UMTS) frequency bands. GSM operation can include transmission in a frequency range of about 824 MHz to about 849 MHz and reception in a frequency range of about 869 MHz to about 894 MHz. EGSM operation can include transmission in a frequency range of about 880 MHz to about 914 MHz and reception in a frequency range of about 925 MHz to about 960 MHz. DCS operation can include transmission in a frequency range of about 1710 MHz to about 1785 MHz and reception in a frequency range of about 1805 MHz to about 1880 MHz. PDC operation can include transmission in a frequency range of about 893 MHz to about 953 MHz and reception in a frequency range of about 810 MHz to about 885 MHz. PCS operation can include transmission in a frequency range of about 1850 MHz to about 1910 MHz and reception in a frequency range of about 1930 MHz to about 1990 MHz. Other bands can also be used in embodiments according to the invention.

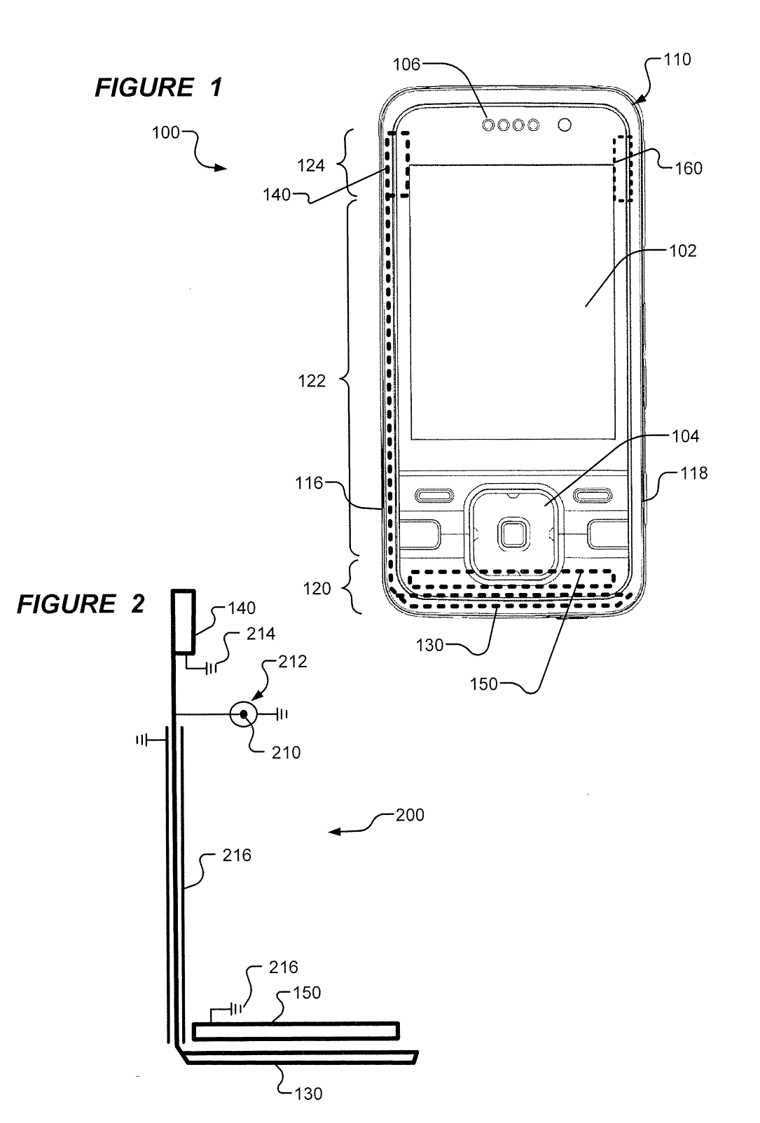

FIG. 1 illustrates a multi-band wireless communications terminal 100 according to some embodiments of the present invention. The terminal 100 includes a housing 110, which for purposes of exemplary description herein is shown as including a front surface and an opposite back surface that extend between opposing side surfaces 116 and 118 and between opposing top and bottom end surfaces to define a cavity therein. A display device 102, a user input interface 104 (e.g. keypad and/or keyboard), and an ear speaker 106 are at least partially disposed in the front surface of the housing 110. A multi-band communications antenna (illustrated in dashed lines) along with various electronic communications circuitry described further below are enclosed within the housing 110 and are configured to transmit and receive wireless communication signals with another communication device (e.g. terminal, base station, etc.) through a plurality of frequency bands.

Some embodiments of the present invention are directed to configuring the antenna to include a low band radiator line 130 that is spaced apart from a first high band radiator line 140 and which are both connected to a common single RF feed node and ground node. The spaced apart low and high band radiator lines 130 and 140 may be integrated in the housing 110 in way that may improve the performance of the multi-band antenna and/or that may be more efficiently integrated within the possibly tight available space within the housing 110. The antenna may further include a second high band radiator line 150 that feed RF signals through inductively coupling to the low band radiator line 130.

When the terminal 100 is being used for a voice call, the user's hand typically covers a central region 122 of the housing 110 while the housing 110 is supported to place the speaker 106 adjacent to the user's ear. In accordance with some embodiments, the low band radiator line 130 resides in a bottom region 120 of the housing 110 that is below the central region 122 where the user's hand is located and spaced apart from an edge of a ground plane of a printed circuit board that electrically interconnects the electronic communications circuitry. In contrast, the first high band radiator line 140 resides in a top region 124 of the housing 110 that is above the central region 122 and may extend along a side edge of and/or reside at least partially on the printed circuit board.

Placing the low band radiator line 130 in the bottom region 120 away from an expected location of the user's hand on the central portion 122 of the housing 110 may improve the low band operational characteristics of the antenna by providing a sufficient aperture and overcoming interference that may be caused by the user's hand and/or by conductive layers/traces on the printed circuit board and/or the electronic components thereon. the high band radiator line 140 may preferably be placed in the top region 124 above the expected location of the user's hand and also away from the top end of the housing 110 (e.g., about 5 mm away from a top end inner surface of the housing 110) to avoid high SAR that may otherwise result from overly close spacing between the high band radiator line 140 and the user's head while touching the housing 110 over the speaker 106 during voice communications.

FIG. 2 illustrates the multi-band antenna of FIG. 1 configured according to according to some nonlimiting embodiments of the present invention. Referring to FIG. 2, the antenna 200 includes radiator lines 130, 140, and 150 that respectively resonant in three different frequency ranges. The radiator lines 130, 140, and 150 can be integrally formed on a flexible dielectric film surface. For example, the three radiator lines 130, 140, and 150 may be deposited or otherwise formed from a conductive material (e.g. 9-10 μm width lines) in a pattern that extends across a flexible film. For example, the three radiator lines 130, 140, and 150 may be formed from a copper sheet or, alternatively, may be formed from a copper layer that is deposited on a flexible dielectric ribbon that is fixedly connected to and supported by various interior surfaces of the housing 110. It will be understood that antennas according to embodiments of the invention may be formed from other conductive materials and are not limited to copper.

It will be understood by those skilled in the art in view of the present description that the antenna 200 may be used for transmitting and/or receiving RF electromagnetic radiation to/from the multi-band wireless terminal 100 to support communications in multiple frequency bands. In particular, during transmission, the low band, first high band, and second high band radiator lines 130-150 resonate in response to signals received from a transmitter portion of a transceiver and radiate corresponding RF electromagnetic radiation into free-space in their corresponding frequency bands. During reception, the low band, central band, and high band radiator lines 130-150 resonate responsive to incident RF electromagnetic radiation received via free-space and provide a corresponding signal (in their corresponding frequency band) to the transceiver circuitry.

The first high band radiator line 140 may, for example, be configured as a conductive loop, a flat conductive patch, and/or a meandering conductive path which may be formed on a flexible film surface. The first high band radiator line 140 is connected to a RF feed node 210 via a conductive strip or coaxial cable 212 and to a ground node 214 (e.g., a ground plane). The first high band radiator line 140 is configured to resonate in a first frequency range responsive to first electromagnetic radiation that is coupled to a feed node 210 by communications circuitry, such as the circuitry described below.

In some embodiments, the high band radiator line 140 may be configured as a planar inverted F-antenna (PIFA) or a reverse-fed PIFA (RFPIFA). The antenna may not be strictly “planar” although, in the vernacular of the art, it might still be referred to as a PIFA/RFPIFA. When the first high band radiator line 140 is configured as a PIFA/RFPIFA, it can include a conductive radiating plane that is spaced apart from a conductive ground plane, such as described in U.S. Pat. Nos. 6,538,604; 6,943,733; and/or 6,980,154, the contents of each of which are hereby incorporated by reference as if recited in full herein.

The low band radiator line 130 may, for example, be configured as a flat conductive patch and/or a meandering conductive path which may be formed on a flexible film surface. The low band radiator line 130 is connected to the RF feed node 210, via a coaxial cable and/or a conductive stripline 216. The stripline may be formed on a printed circuit board of the terminal 100. The low band radiator line 130 may be connected through the first high band radiator line 140 to the ground node 214, and may not be directly connected to another ground node. The low band radiator line 130 is configured to resonate in a second frequency range responsive to second electromagnetic radiation that is coupled to the feed node 210. Accordingly, the ground node 214 acts as a ground node for the first high band radiator line 140 and for the low band radiator line 130 so that they are configured to resonate in their respective frequency bands.

The second high band radiator line 150 may, for example, be configured as a conductive loop, a flat conductive patch and/or a meandering conductive path which may be formed on a flexible film surface, which may be the same flexible film surface on which the first high and low band radiator lines 140 and 130 may be formed. The second high band radiator line 150 extends parallel and closely spaced to the low band radiator line 130, with a dielectric layer therebetween, to be inductively coupled to the low band radiator line 130 and resonate in a third frequency range that is complementary to the first and second frequency ranges, responsive to the second electromagnetic radiation being provided to the RF feed node 210. For example, the second high band radiator line 150 may be formed on an opposite side of a flexible dielectric surface from the low band radiator line 130. The second high band radiator line 150 is conductively connected to another ground node (number already used elsewhere) and is not conductively connected to the RF feed node 210 (i.e., only inductively connected thereto).

The first, second, and third resonant frequency ranges of the respective first high, low, and second high band radiator lines 140, 130, and 150 can be substantially different from one another and may be exclusive of one another (i.e., nonoverlapping frequency ranges). The resonant frequency ranges of the first high and low band radiator lines 140 and 130 can be separately defined during manufacture by, for example, controlling their respective lengths (e.g., patch lengths, meandering line lengths and/or number of meandering turns) and/or their respective conductive distances from the RF feed node 210 and the ground node 214. The resonant frequency range of the second high band radiator line 150 can be defined during manufacture by, for example, controlling its length (e.g., loop length, patch length, meandering line lengths and/or number of meandering turns) relative to conductive features sizes to which it inductively coupled to on the low band radiator line 130.

The first frequency range resonated by the first high band radiator line 140 can be a higher frequency range than the second and third frequency ranges of the low and second high band radiator lines 130 and 150. The third frequency range resonated by the second high band radiator line 150 can be between the first and second frequency ranges. For example, the first high band radiator line 140 may be configured to resonate in a frequency range between 1700 and 2700 MHz, the second high band radiator line 150 may be configured to resonate in a frequency range between 1800 and 2000 MHz, and the low band radiator line 130 may be configured to resonate in a frequency range between 800 and 950 MHz. In one particular embodiment, the first high band radiator line 140 may primarily resonate in a frequency range that includes 1800 MHz, the second high band radiator line 150 may primarily resonate in a frequency range that includes 2100 MHz, and the low band radiator line 130 may primarily resonate in a frequency range that includes 850 MHz.

In some embodiments, the second high band radiator line or another high band radiator line may reside in the top region 124 on an opposite side of the terminal 100 from the first high band radiator line 140 as shown by the dashed antenna line 160 in FIG. 1. The antenna line 160 can be connected to the RF feed node 210 through, for example, a coaxial cable and/or a stripline which may be formed on a printed circuit board of the terminal 100.

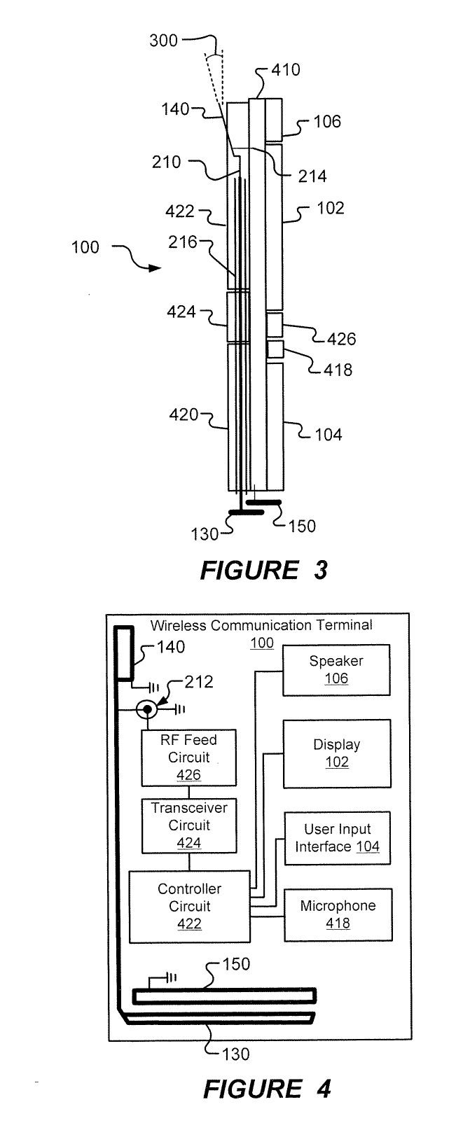

FIG. 3 is a block diagram that illustrates a side view of exemplary components of the terminal 100 of FIG. 1 according to some embodiments of the invention. FIG. 4 is a functional block diagram of the exemplary components of the terminal 100 of FIGS. 1 and 3 according to some embodiments of the invention.

Referring to FIGS. 3 and 4, the terminal 100 can include the tri-band antenna 200, a printed circuit board 410 with an associated ground plane, the speaker 106, the display 102, the user input interface 104 (e.g., keypad/keyboard), a microphone 418, a battery 420, a controller circuit 422, a transceiver circuit 424, and a RF feed circuit 426. The printed circuit board 410 has opposite major surfaces that electrically connects and fixedly support the components 102, 104, and 418-426.

As show in FIG. 3, the low band and second high band radiator lines 130 and 150 of the antenna 200 are spaced apart from an edge of the printed circuit board 410 to avoid interference from the ground plane and/or other electronic components of the printed circuit board 410. The low band and second high band radiator lines 130 and 150 may be positioned below the printed circuit board 410 in the bottom region 120 or in the top region 124 of the housing 110 so as to not overlap the ground plane of the printed circuit board 410. As explained above, it may be advantageous, but not necessary, to position the low band and second high band radiator lines 130 and 150 within the bottom region 120 of the housing 110 to avoid interference with their desired resonant frequencies due to undesirable coupling to a user's hand located on the central region 122 of the housing 110. One or more of the low band, first high band, and/or second highband radiator lines 130-150 may be configured to be spaced apart from edges of the printed circuit board 410 so as to not overlap either of the opposite major surfaces of the printed circuit board 410 to avoid interference that may otherwise occur to their desire resonant frequencies.

The controller circuit 422 may include a general purpose processor and/or digital signal processor which can execute instructions from a computer readable memory that carry out at least some functionality to enable wireless communications through the transceiver circuit 424, the RF feed circuit 426, and the antenna 200 to one or more other wireless communication terminals and/or base stations according to one or more RF communication protocols. The controller circuit 422 may functionally operate the speaker 106, the display 102, the user input interface 104, and the microphone 418. The transceiver circuit 424 may be configured to encode/decode and transmit and receive RF communications according to one or more cellular protocols, which may include, but are not limited to, Global Standard for Mobile (GSM) communication, General Packet Radio Service (GPRS), enhanced data rates for GSM evolution (EDGE), code division multiple access (CDMA), wideband-CDMA, CDMA2000, and/or Universal Mobile Telecommunications System (UMTS), WiMAX, and/or Long Term Evolution (LTE).

The RF feed circuit 426 is configured to amplify and supply electromagnetic radiation signal to the feed node 210 within a selected one of at least three frequency ranges that resonate different ones of the three radiator lines 130-150. The electromagnetic radiation signal from the RF feed circuit 426 may be conducted to the feed node 210 through a coaxial cable 212, a flex line, and/or a conductive trace on the printed circuit board 410. The RF feed circuit 426 may be further configured to selectively amplify and supply a signal that is received by any of the three radiator lines 130-150 from another communication terminal/base station to the transceiver circuit 424. To facilitate effective performance during transmission and reception, the output/input impedance of the RF feed circuit 426 can be “matched” to an impedance of the antenna 200 between the feed node 210 and the ground node 220 to maximize power transfer between the RF feed circuit 426 and the antenna 200. It will be understood that, as used herein, the term “matched” includes configurations where the impedances are substantially electrically tuned to compensate for undesired antenna impedance components to provide a particular impedance value.

Referring to FIGS. 1-4, the low band, second high band, and first high band radiator lines 130, 150, and 140 can be supported by various interior surfaces of the housing 110 and, as described above, can have substantially different lengths and correspondingly substantially different resonant frequency ranges. For example, the low band radiator line 130 and the second high band radiator line 150 may extend across at least a majority of the width of the bottom region 120 of the housing 110. Along at least a majority of their lengths, the low band radiator line 130 and the second high band radiator line 150 may be fixedly supported by an inner front/back surface and/or by an inner end surface of the housing 110 in the bottom region 120. In one embodiment, the low band radiator line 130 and/or the second high band radiator line 150 may extend entirely across the terminal 100 and be fixedly supported by the front/back surface and/or the inner end surface of the housing 110 and by the opposite facing side inner-surfaces 116-118 of the housing 110.

The first high band radiator 140 can extend along and be fixedly supported by an inner-surface of one of the side surfaces 116 or 118. For example, the first high band radiator 140 may extend along one of the side surfaces 116 or 118 of the housing 110 and may be positioned between that side surface and an edge of the printed circuit board 410. Accordingly, a major portion of the low band radiator line 130 and a major portion of the first high band radiator line 140 may extend in substantially perpendicular directions, such as in respective directions across a width and a length of the terminal 100.

As shown in FIG. 3, the first high band radiator line 140 may extend along a major portion thereof in a direction that is titled at a non-zero angle 300 away from the front surface of the housing 110 so that the high band radiator line 140 is more uniformly spaced along its length from to a user's fingers while the housing 110 is tilting toward the user's face to position the speaker 106 adjacent to or touching the user's ear. Alternatively or additionally, the first high band radiator line 140 may extend along a major portion thereof in a direction that is titled at a non-zero angle 300 away from the front surface of the housing 110 so that the high band radiator line 140 is more uniformly spaced along its length from to a user's face (i.e., substantially parallel to the user's face) while the housing 110 is tilting toward the user's face to position the speaker 106 adjacent to or touching the user's ear. It has been determined through experimentation that tilting the first high band radiator line 140 at least 10°, and maybe more preferably at least 15°, away from the front surface of the housing 110 may provide a more consistent and desirable resonant frequency during operation because of more uniformly spaced that is obtained along its length relative to a user's hand while the speaker 106 is placed adjacent to or touching the user's ear during a voice call.

Although the antenna 200 has been described in the context of the low band radiator line 130 extending in a direction across the terminal 100 and the second high band radiator line 150 extending in a direction along a length of the terminal 100, the invention is not limited thereto. For example, the first high band radiator line 140 may extend in a direction across the terminal 100, and/or the low band radiator line 130 and/or the second high band radiator line 150 may extend in a direction along a length of the terminal 100.

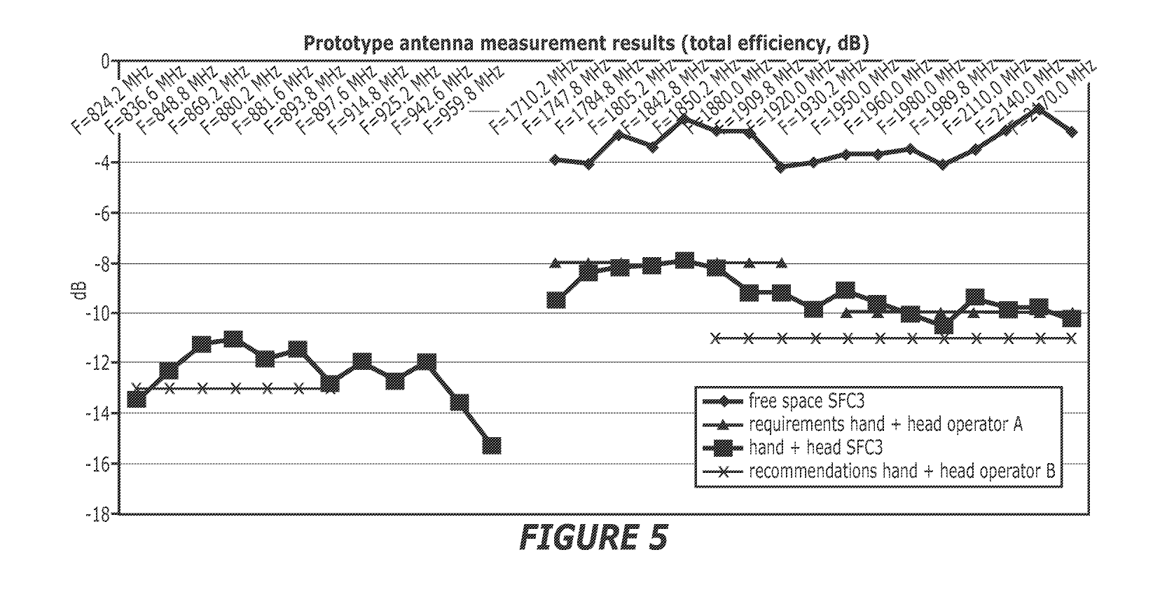

FIG. 5 is a graph that illustrates exemplary total antenna efficiency that may be provided by the pentaband antenna 200 of FIGS. 1-4 in a 100 mm long monoblock handset in free space and with phantom head and hand in accordance with some embodiments of the invention. Referring to FIG. 5, the exemplary antenna total efficiency LogMag is illustrated along the y-axis and the corresponding frequencies are illustrated along the x-axis. It is observed that the antenna provides good performance (i.e., without undesirable significant canceling currents) in the above-described exemplary first, second, and third frequency ranges of the low band radiator line 130, the first high band radiator line 140, and the second high band radiator line 150, which are particularly important RF frequencies for certain cellular communication protocols.

Although various embodiments of multi-band antennas have been described in the context of the communication terminal 100, which has been illustrated as anon-flip type cellular phone, the invention is not limited thereto. Various embodiments of the multi-band antennas may instead be utilized in foldable “clamshell” type wireless communication terminals and in other types of wireless communication terminals that are configured to transmit and receive in a plurality of frequency bands.

Many alterations and modifications may be made by those having ordinary skill in the art, given the benefit of present disclosure, without departing from the spirit and scope of the invention. For example, antennas according to embodiments of the invention may have various shapes, configurations, and/or sizes and are not limited to those illustrated. Therefore, it must be understood that the illustrated embodiments have been set forth only for the purposes of example, and that it should not be taken as limiting the invention as defined by the following claims. The following claims are, therefore, to be read to include not only the combination of elements which are literally set forth but all equivalent elements for performing substantially the same function in substantially the same way to obtain substantially the same result. The claims are thus to be understood to include what is specifically illustrated and described above, what is conceptually equivalent, and also what incorporates the essential idea of the invention.

What is claimed:

1. A wireless communications terminal comprising:
a housing having an interior surface that is configured to enclose at least a transceiver circuit and a RF feed circuit that provide a RF signal to a RF feed node, wherein the housing extends between opposing top and bottom end surfaces and between opposing first and second side surfaces;
a first radiator line that primarily extends along one of the side surfaces, wherein the first radiator line is connected to the RF feed node and to a first ground node, and is configured to resonate in a first frequency range responsive to a first RF signal being provided to the RF feed node; and
a second radiator line that is connected to the RF feed node and extends across at least a majority of a width of the housing between first and second side surfaces, wherein the second radiator line is configured to resonate in a second frequency range, which is lower than the first frequency range, responsive to a second RF signal being provided to the RF feed node.

2. The wireless communications terminal of claim 1, wherein the second radiator line is grounded through the first ground node to resonate in the second frequency range.

3. The wireless communications terminal of claim 1, wherein:
the first frequency range resonated by the first radiator line includes frequencies between 1700 and 2700 MHz; and
the second frequency range resonated by the second radiator line includes frequencies between 800 and 960 MHz.

4. The wireless communications terminal of claim 1, wherein:
the first and second radiator lines are integrally formed as a single conductive layer on a flexible film surface and are connected by a coaxial cable or a stripline on a printed circuit board.

5. The wireless communication terminal of claim 4, wherein:
the first radiator line extends on the flexible film surface along and is fixedly attached to one of the first and second side surfaces of the housing; and
the second radiator line extends on the flexible film surface across the terminal and is fixedly attached to the first and second side surfaces.

6. The wireless communication terminal of claim 5, wherein:
the first radiator line is fixedly attached along at least a major length thereof to one of the first and second side surfaces of the housing; and
the second radiator line is fixedly attached along at least a major length thereof to the bottom end surface.

7. The wireless communications terminal of claim 4, wherein:
the first and second radiator lines each comprise a flat conductive patch attached to the flexible film surface.

8. The wireless communications terminal of claim 4, wherein:
the first and second radiator lines each comprise a meandering conductive path attached to the flexible film surface.

9. The wireless communications terminal of claim 4, wherein:
the first radiator line comprises a conductive loop attached to the flexible film surface; and
the second radiator line comprises a flat conductive patch and/or a meandering conductive path attached to the flexible film surface.

10. The wireless communications terminal of claim 1, further comprising:
a third radiator line that extends parallel to and is closely spaced to the second radiator line and is inductively and/or capacitively coupled to the second radiator line to resonate in a third frequency range, which is at least as high as the second frequency range, responsive to the second electromagnetic radiation being provided to the RF feed node.

11. The wireless communications terminal of claim 10, wherein:
the first frequency range resonated by the first radiator line includes frequencies between 1700 and 2700 MHz;
the second frequency range resonated by the second radiator line includes frequencies between 800 and 960 MHz; and
the third frequency range resonated by the third radiator line includes frequencies between 1800 and 2700 MHz.

12. The wireless communications terminal of claim 10, wherein the third radiator line extends across the terminal and is fixedly attached to the first and second side surfaces.

13. The wireless communications terminal of claim 1, wherein:
the first radiator line is located within a top region of the housing that is above a central region of the housing which is covered by a user's hand while holding the terminal to position a speaker within the housing adjacent to the user's ear; and
the second radiator line is located within a bottom region of the housing that is below the central region of the housing.

14. The wireless communications terminal of claim 13, wherein:
the first radiator line is spaced apart from the top end of the housing between a location of the speaker and the central region of the housing.

15. The wireless communications terminal of claim 1, further comprising:
a printed circuit board that electrically connects and fixedly supports the transceiver circuit, the RF feed circuit, and the RF feed node, the printed circuit board having opposing major surfaces,
wherein the first and second radiator lines do not overlap either of the opposing major surfaces of the printed circuit board.

16. The wireless communications terminal of claim 15, wherein:
the second radiator line is located in a bottom region of the housing relative to how the housing is held by a user to position a speaker within the housing adjacent to the user's ear, and the second radiator line is spaced apart from an edge of the printed circuit board.

17. The wireless communications terminal of claim 1, wherein:
the first radiator line extends along a major portion thereof in a first direction, the second radiator line extends along a major portion thereof in a second direction, and the first and second directions are substantially perpendicular.

18. The wireless communications terminal of claim 1, wherein:
the first radiator line extends along a major portion thereof in a first direction that is titled at least 10° away from a front surface of the housing so that the first radiator line is more uniformly spaced along its length from a user's fingers while the housing is tilting toward the user's face while the terminal is held to position a speaker within the housing adjacent to the user's ear.

19. A wireless communications terminal comprising:
a housing having an interior surface that is configured to enclose at least a transceiver circuit and a RF feed circuit that provide a RF signal to a RF feed node, wherein the housing extends between opposing top and bottom end surfaces and between opposing first and second side surfaces;
a first radiator line that primarily extends along one of the side surfaces, wherein the first radiator line is connected to the RF feed node and to a first ground node, and is configured to resonate in a first frequency range responsive to a first RF signal being provided to the RF feed node, wherein the first radiator line is located within a top region of the housing that is above a central region of the housing which is covered by a user's hand while holding the terminal to position a speaker within the housing adjacent to the user's ear;
a second radiator line that is connected to the RF feed node and extends across at least a majority of a width of the housing between first and second side surfaces, wherein the second radiator line is configured to resonate in a second frequency range, which is lower than the first frequency range, responsive to a second RF signal being provided to the RF feed node, wherein the second radiator line is located within a bottom region of the housing that is below the central region of the housing; and
a third radiator line that extends parallel to and is closely spaced to the second radiator line and is inductively and/or capacitively coupled to the second radiator line to resonate in a third frequency range, which is at least as high as the second frequency range, responsive to the second electromagnetic radiation being provided to the RF feed node.

20. The wireless communications terminal of claim 19, wherein:
the first and second radiator lines are integrally formed as a single conductive layer on a flexible film surface and are connected by a coaxial cable and/or a stripline on a printed circuit board;
the first radiator line extends on the flexible film surface along and is fixedly attached along at least a major length thereof to one of the first and second side surfaces of the housing; and
the second radiator line extends on the flexible film surface across the terminal and is fixedly attached to the first and second side surfaces and is fixedly attached along at least a major length thereof to the bottom end surface.
